(19) United States
(12) Patent Application Publication
(10) Pub. No.: US 2008/0123649 A1
(43) Pub. Date: May 29, 2008

(54) SYSTEMS AND METHODS FOR BROADCAST STORM CONTROL

(75) Inventors: Chun-Cheng Wang, Taipei (TW); Ying-Chung Chen, Taipei (TW); Ming-Chao Chung, Taipei (TW); Wei-Pin Chen, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 11/458,725

(22) Filed: Jul. 20, 2006

(51) Int. Cl. H04L 12/56

(52) U.S. Cl. 370/392

(57) ABSTRACT

Systems and methods for broadcast storm control. A system for broadcast storm control comprises a plurality of ports and a processing module. Each port comprises a counter counting the number of broadcast packets received in a time unit, and a corresponding drop flag set based on the counter value and an ingress rate thereof. The processing module receives a packet from a specific port within the ports, and drops or forwards the packet to at least one of the ports according to the drop flag corresponding to the specific port.

### BACKGROUND OF THE INVENTION

1. Field of the Invention

The invention relates generally to network transmission, and, more particularly, to systems and methods for broadcast storm control.

2. Description of the Related Art

In network transmission, a switch has multiple ports to connect multiple packet switched network segments and forward data packets based on MAC addressing. When a packet is received from a port, the switch selectively transmits the packet from specific ports based on the destination MAC address recorded in the packet. If the destination MAC address is known, the packet is forwarded to the corresponding port in the MAC address table. If the destination MAC address is unknown, for example, a broadcast address, the switch transmits the packets to all of the ports except the incoming port. If the destination port is the same as the originating port, the packet is filtered out and not forwarded.

When broadcast packets are received, each packet prompts a receiving port to respond by broadcasting its own packets on the network that in turn prompt further responses, and so on. The network situation is called broadcast storm and results in serious negative impact on network performance. FIG. 1A is a schematic diagram illustrating packet broadcasting. In FIG. 1A, ports 0 and 24 transmit broadcast packets in a switch. Port 1 responds by forwarding the broadcast packet to port 2, and port 2 responds by forwarding the broadcast packet to port 3, and so on. If port 24 is a giga port, transmitting more packets than port 0, and causes port 2 congestion, a conventional broadcast storm control stops ports 0 and 24 from transmitting broadcast packets again, as shown in FIG. 1B. That is, conventional broadcast storm control is based on congestion control and is subject to incoming broadcat packets. If a switch has a congestion situation due to broadcast packets, the incoming broadcast packets from all ports are stopped.

### BRIEF SUMMARY OF THE INVENTION

Systems and methods for broadcast storm control are provided.

An embodiment of a system for broadcast storm control comprises a plurality of ports and a processing module. Each port comprises a corresponding drop flag and a counter counting the number of broadcast packets received in a time unit. The drop flag is set based on the counter value and an ingress rate of the port. The processing module receives a packet from a specific port within the ports, and processes the packet according to the drop flag corresponding to the specific port.

In an embodiment of a method for broadcast storm control, a specific port within a plurality of ports counts the number of broadcast packets received in a time unit. A drop flag corresponding to the specific port is set based on the number of the broadcast packets and an ingress rate of the specific port. A packet from the specific port is dropped or forwarded to at least one of the ports according to the drop flag corresponding to the specific port.

Systems and methods for broadcast storm control may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1A is a schematic diagram illustrating packet broadcasting;

FIG. 1B is a schematic diagram illustrating a broadcast storm;

FIG. 2 is a schematic diagram illustrating an embodiment of a system for broadcast storm control;

FIG. 3 is a flowchart of an embodiment of a method of setting for respective ports;

FIG. 4 is a flowchart of an embodiment of a method of drop flag maintenance;

FIG. 5 is a flowchart of an embodiment of a method for broadcast storm control;

FIG. 6 is an example illustrating the relationship between the counter value, queue limit, ingress quota, and drop flag; and

FIG. 7 is a schematic diagram illustrating an embodiment of broadcast storm control.

### DETAILED DESCRIPTION OF THE INVENTION

Systems and methods for broadcast storm control are provided.

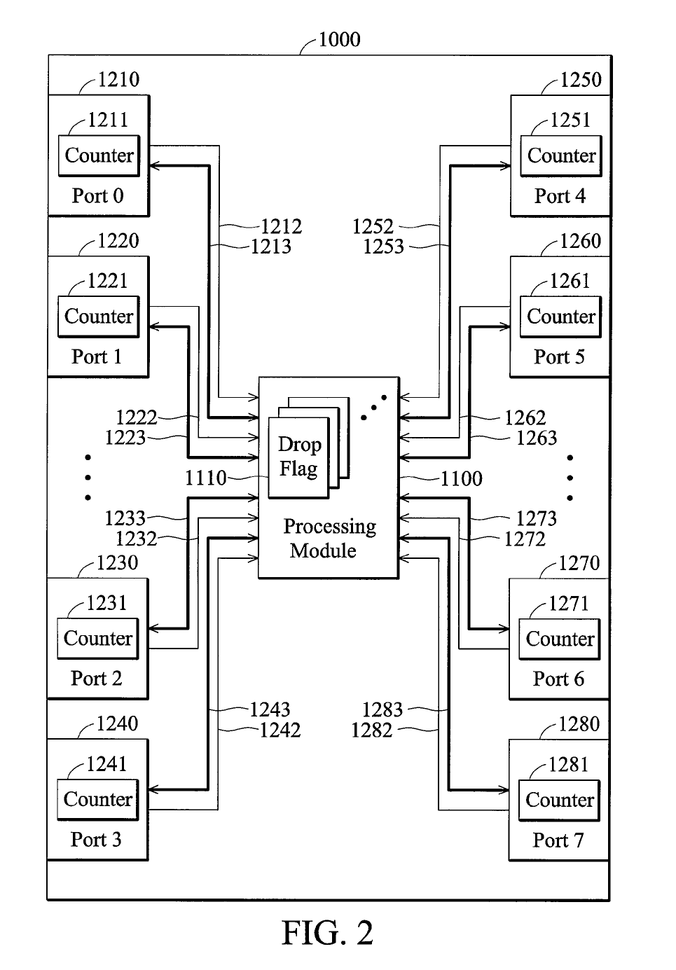

FIG. 2 is a schematic diagram illustrating an embodiment of a system for broadcast storm control. The system 1000 may be a network switch. The system 1000 comprises a plurality of ports (1210, 1220, 1230, 1240, 1250, 1260, 1270 and 1280) and a processing module 1100. Each port has a respective ingress rate, and connects to various interfaces and devices and receives packets therefrom. The received packets are transmitted to the processing module 1100 via connections (1213, 1223, 1233, 1243, 1253, 1263, 1273 and 1283) for further processing. The processing module 1100 comprises a MAC address table and a forwarding table (not shown) used for forwarding packets between the ports. It is understood that the switch operation and forwarding methods are well known, and are thus omitted herefrom. Each port comprises a counter (1211, 1221, 1231, 1241, 1251, 1261, 1271 and 1281) counting the number of broadcast packets received in a time unit. The counter value is transmitted to the processing module 1100 via connection (1212, 1222, 1232, 1242, 1252, 1262, 1272 and 1282) for further processing. It is understood that the connection pairs (1212 and 1213, 1222 and 1223, 1232 and 1233, 1242 and 1243, 1252 and 1253, 1262 and 1263, 1272 and 1273, and 1282 and 1283) may be respectively designed in one channel and/or interface. The processing module 1100 comprises a plurality of drop flags 1110 corresponding to respective ports. The setting and usage of the drop flags for broadcast storm control are discussed later.

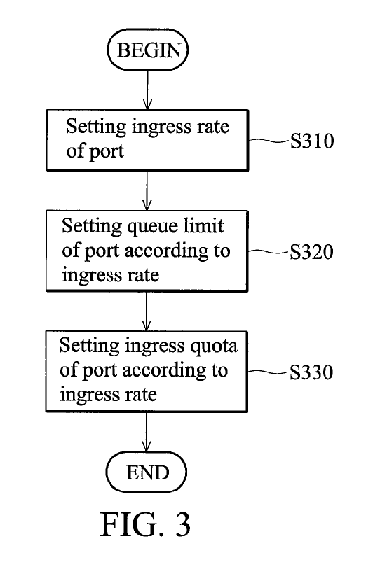

FIG. 3 is a flowchart of an embodiment of a method of setting for respective ports. As described, each port may have a respective ingress rate, and in step S310, the ingress rate of a port is first set. In some embodiments, the ingress rate of a port can be set according to the requirement and importance of the device connected to the port. In step S320, a queue limit of the port is set according to the ingress rate thereof, and in step S330,an ingress quota of the port is set according to the ingress rate thereof. In some embodiments, the queue limit and ingress quota may be a fraction such as ½, ¼, ⅛ and 1/16 of the ingress rate, with the queue limit exceeding the ingress quota. The usage of the queue limit and ingress quota is discussed later.

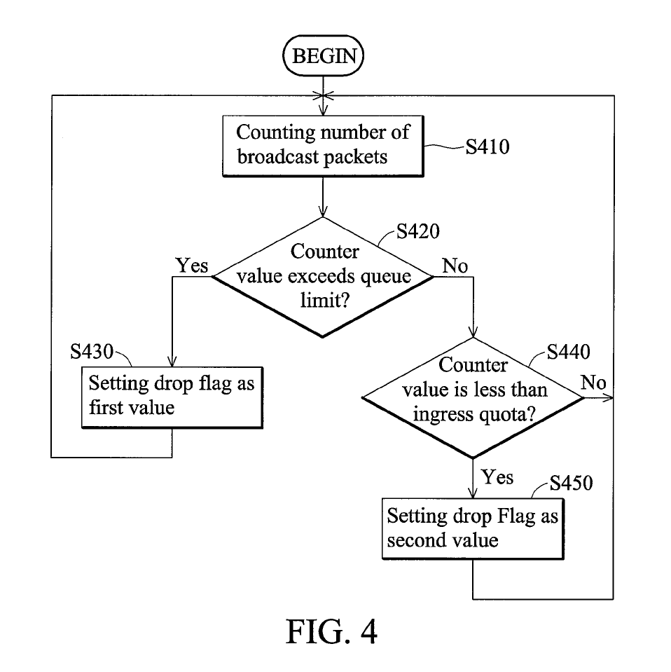

FIG. 4 is a flowchart of an embodiment of a method of drop-flag maintenance. In step S410, the counter of a port counts the number of broadcast packets received in a time unit. In step S420, it is determined that whether the counter value exceeds the queue limit. If so (Yes in step S420), in step S430, the drop flag corresponding to the port is set as a first value such as 1, and the procedure returns to step S410. If not (No in step S420), in step S440, it is determined that whether the counter value is less than the ingress quota. If not (No in step S440), the procedure returns to step S410. If so (Yes in step S440), in step S450, the drop flag corresponding to the port is set as a second value such as 0, and the procedure returns to step S410. It is understood that the setting of drop flags may be performed in the processing module 1100. In some embodiments, the setting of drop flags may be also performed in respective ports, and then transmitted to the processing module 1100.

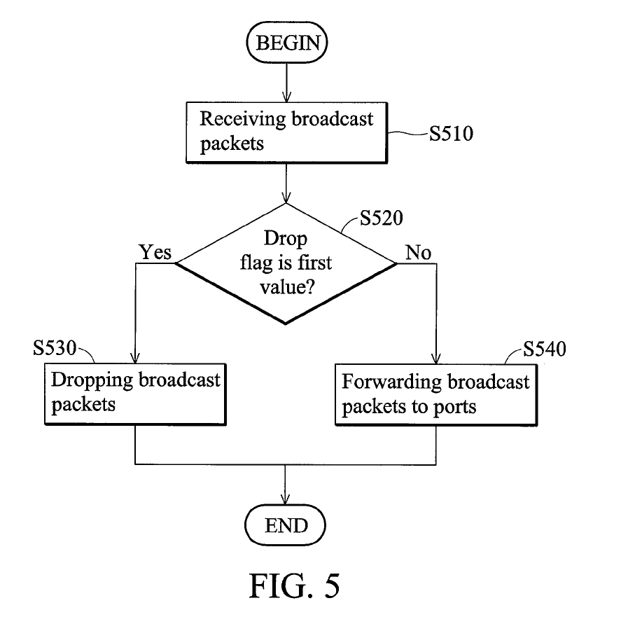

FIG. 5 is a flowchart of an embodiment of a method for broadcast storm control. In step S510, a packet such as broadcast packet is received from a specific port. In step S520, it is determined that whether the drop flag corresponding to the specific port is the first value such as 0. If so (Yes in step S520), in step S530, the broadcast packet is dropped. If not (No in step S520), in step S540, the broadcast packet is forwarded to at least one of the ports according to the operation and forwarding methods of the switch.

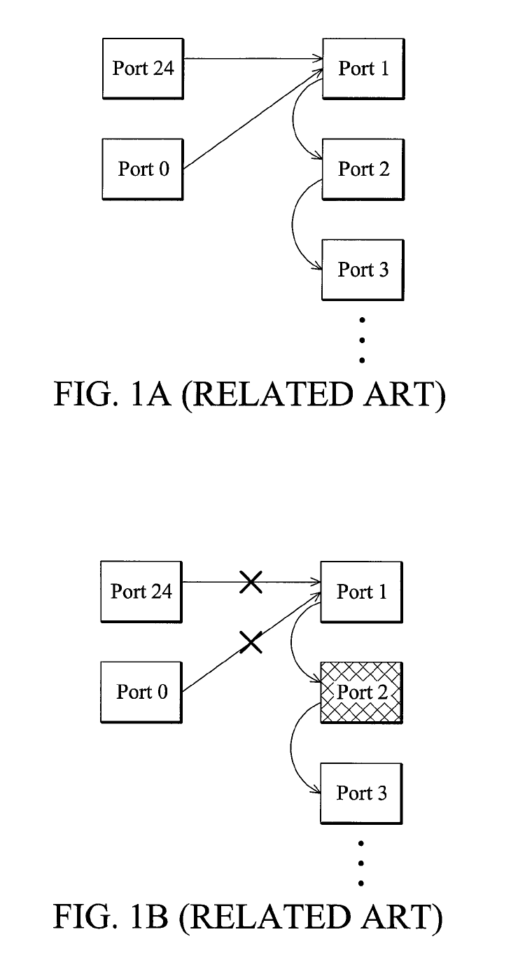

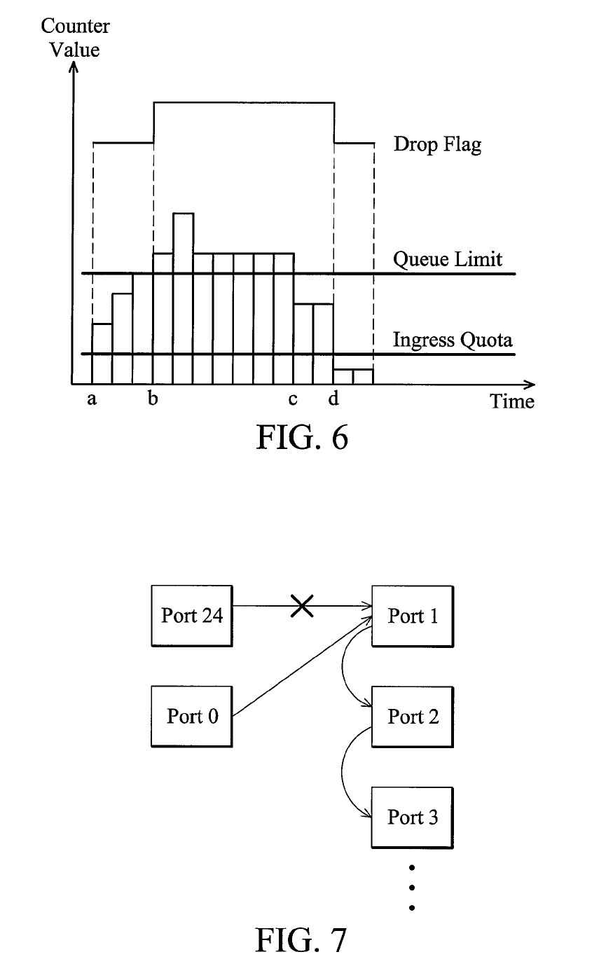

FIG. 6 is an example illustrating the relationship between the counter value, queue limit, ingress quota, and drop flag. The drop flag of a port is originally at 0. At time “a”, the counter value indicating the number of broadcast packets received by the port in a time unit does not exceed the queue limit, the drop flag is not changed. At time “b”, since the counter value exceeds the queue limit, the drop flag is set as 1. At time “c”, the counter value does not exceed the queue limit. Since the counter value still exceeds the ingress quota, the drop flag is still held at 1. At time “d”, since the counter value is less than the ingress quota, the drop flag is set as 0. In this example, the broadcast packets of the port received within the window between time “b” to time “d” are dropped. FIG. 7 is a schematic diagram illustrating an embodiment of broadcast storm control. Similarly to FIG. 1A, ports 0 and 24 transmit broadcast packets in a switch. If port 24 is a giga port, transmitting packets more than port 0, and causes port 2 congestion, only port 24 is stopped from transmitting broadcast packets again since the counter value thereof may exceed the queue limit correspondingly, and port 0 can proceed to transmit broadcast packets if the counter value thereof does not exceed the queue limit correspondingly.

Systems and methods for broadcast storm control, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A system for broadcast storm control, comprising:
a plurality of ports, of which each comprising a counter counting the number of broadcast packets received in a time unit, with a drop flag set based on the counter value and an ingress rate thereof; and
a processing module for receiving a packet from a specific port within the ports, and processing the packet according to the drop flag corresponding to the specific port.

2. The system of claim 1 wherein the drop flag is set as a first value if the counter value exceeds a queue limit determined by the ingress rate of the specific port, and the processing module drops the packet if the drop flag is the first value.

3. The system of claim 1 wherein the drop flag is set as a second value if the counter value is less than an ingress quota determined by the ingress rate of the specific port, and the processing module forwards the packet to at least one of the ports if the drop flag is the second value.

4. The system of claim 1 wherein the drop flag is set as a first value if the counter value exceeds a queue limit determined by the ingress rate of the specific port, and the drop flag is set as a second value if the counter value is less than an ingress quota determined by the ingress rate of the specific port, in which the queue limit exceeds the ingress quota, and the processing module drops the packet if the drop flag is the first value and forwards the packet to at least one of the ports if the drop flag is the second value.

5. The system of claim 1 wherein the packet is a broadcast packet.

6. A method for broadcast storm control for use in a plurality of ports, of which each comprising a drop flag, comprising:
counting the number of broadcast packets received in a time unit;
setting the drop flag based on a counter value and an ingress rate; and
processing a packet from an specific port according to the drop flag corresponding to the specific port.

7. The method of claim 6 further comprising:
setting the drop flag as a first value if the number of the broadcast packets exceeds a queue limit determined by the ingress rate of the specific port; and
dropping the packet if the drop flag is the first value.

8. The method of claim 6 further comprising:
setting the drop flag as a second value if the number of the broadcast packets is less than an ingress quota determined by the ingress rate of the specific port; and
forwarding the packet to at least one of the ports if the drop flag is the second value.

9. The method of claim 6 further comprising:
setting the drop flag as a first value if the number of the broadcast packets exceeds a queue limit determined by the ingress rate of the specific port;
setting the drop flag as a second value if the number of the broadcast packets is less than an ingress quota determined by the ingress rate of the specific port, in which the queue limit exceeds the ingress quota;
dropping the packet if the drop flag is a first value; and
forwarding the packet to at least one of the ports if the drop flag is a second value.

10. The method of claim 6 wherein the packet is a broadcast packet.

11. A system for broadcast storm control, comprising:
a plurality of ports, of which each comprising a counter counting the number of broadcast packets received in a time unit;
a plurality of drop flags corresponding to respective ports, wherein each of the plurality of drop flags is set as a first value if the corresponding counter value exceeds a queue limit determined by an ingress rate of the corresponding port, and as a second value if the corresponding counter value is less than an ingress quota determined by the ingress rate of the corresponding port, in which the queue limit exceeds the ingress quota; and
a processing module for receiving a packet from a specific port within the ports, dropping the packet if the drop flag corresponding to the specific port is the first value, and forwarding the packet to at least one of the ports if the drop flag corresponding to the specific port is the second value.
